(19) United States
(12) Patent Application Publication
(10) Pub. No.: US 2006/0271672 A1
(43) Pub. Date: Nov. 30, 2006

(54) SYSTEM AND METHOD FOR LOADING VARIOUS OPERATING SYSTEMS FROM A REMOTE CONSOLE

(76) Inventors: Chih-Chiang Liu, Shenzhen (CN); Wei-Yuan Chen, Shenzhen (CN); Li-Ying Chang, Shenzhen (CN); Shin-Hui Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,529

(22) Filed: Apr. 3, 2006

(30) Foreign Application Priority Data
May 24, 2005 (CN) 200510034864.6

(51) Int. Cl. G06F 15/173

(52) U.S. Cl. 709/224

(57) ABSTRACT

A system for loading various operating systems includes a remote console (1) and multiple clients (3). The remote console includes a client controlling module (10) for checking connection statuses between the remote console and the clients, and for determining whether the already connected clients can receive orders from the remote console, and for selecting object clients from the clients that can receive orders; a code setting module (11) for selecting operating systems to be loaded in the object clients, and setting codes of disk partition sections in the object clients respectively; and an order sending module (12) for sending orders and the codes. Each client includes a receiving module (30) for receiving the orders and the codes, and executing the orders; and an amending module (32) for amending disk partition tables to configure the disk partition sections as boot sections according to the codes. A related method is also disclosed.

### FIELD OF THE INVENTION

The present invention relates to a system and method for loading various operating systems from a remote console.

### DESCRIPTION OF RELATED ART

Before the advent of the distributed systems of today, a single client would serve multiple users. When an operating system needs to be replaced, the system manager would only have to load the new operating system in a single client. However, in today's distributed processing environment, it is quite common that each user has his or her own client computer with its own operating system, where the clients are networked together. Thus, when an operating system replacement is performed, the process of loading a new operating system from an I/O device has to be performed with respect to each individual client in the network. The replacement of multiple clients can be quite time consuming, and it can be even more burdensome in an operating system development environment where the operating system replacements may be performed as frequently as once a week. Thus, it would be preferable in a distributed environment to load the operating system by the control of a remote console and thereafter the remote console sends corresponding orders over the network to each connected client.

For example, after computer components (such as a motherboard or a central processing unit etc) have been upgraded by developers, the computer components need to be tested by test persons before mass-production and distribution into the market. During the process of testing, the test persons need to load various operating systems in multiple clients to test whether the computer components run normally under various platforms. Generally, each test person have to control multiple clients and operate the clients one by one, such as booting each computer and loading different operating systems in the clients respectively, to test the computer components under the different operating systems for obtaining test results. Thus, it is burdensome for the test persons to finish the above operations.

What is needed, therefore, is a system and method which can select required operating systems stored in the clients and load the required operating systems in each client from the remote console. The remote console controls multiple clients at the same time, this can improve test efficiency and reduce the burden of test persons.

### SUMMARY OF INVENTION

One preferred embodiment provides a system for loading various operating systems from a remote console. The system includes at least one remote console and multiple clients. The at least one remote console includes a client controlling module, a code setting module and an order sending module. The client controlling module is used for checking connection statuses between the at least one remote console and the multiple clients, for determining whether the already connected clients can receive orders from the at least one remote console, and for selecting object clients from the clients that can receive orders. The code setting module is used for selecting operating systems to be loaded in the object clients, and for setting codes of disk partition sections in the corresponding object clients respectively. The order sending module is used for sending orders and the codes from the at least one remote console to the object clients.

Another preferred embodiment provides a method for loading various operating systems from a remote console. The method includes the steps of: checking connection statuses between the remote console and the multiple clients; determining already connected clients from the multiple clients; determining whether the already connected clients can receive orders from the remote console; selecting object clients from the already connected clients that can receive orders from the remote console; selecting operating systems that need to be loaded in the object clients; setting codes of disk partition sections in the object clients according to the operating systems to be loaded; sending orders and the codes to the object clients from the remote console; receiving the orders and the codes by the object clients; amending disk partition tables to configure the disk partition sections as boot sections according to the codes; executing the received orders to reboot the object clients; and loading the operating systems in the object clients.

Other advantages and novel features of the present invention will become more apparent from the following detailed description of preferred embodiments when taken in conjunction with the accompanying drawings.

### BRIEF DESCRIPTION OF DRAWINGS

FIG. 1 is a schematic diagram of hardware configuration of a system for loading various operating systems from a remote console in accordance with a preferred embodiment of the present invention; and

FIG. 2 is a flowchart of a method for loading various operating systems from a remote console in accordance with a preferred embodiment of the present invention.

### DETAILED DESCRIPTION

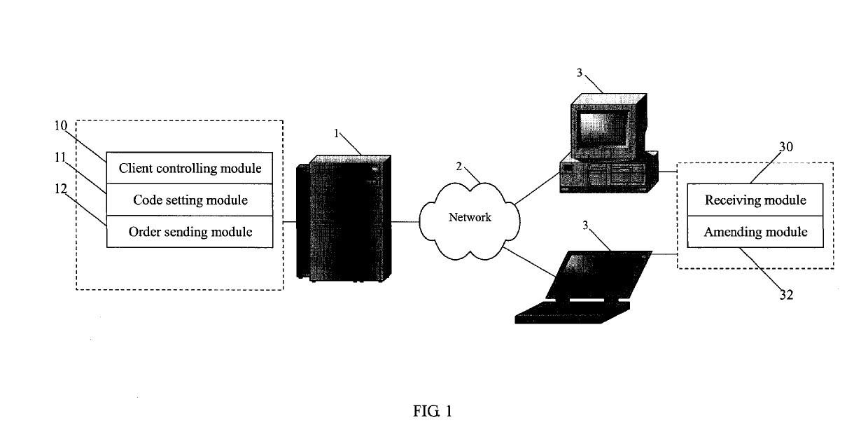

FIG. 1 is a schematic diagram of hardware configuration of a system for loading various operating systems from a remote console (hereinafter, “the system”), in accordance with a preferred embodiment of the present invention. The system includes a remote console 1, a plurality of clients 3 (only two shown), and a network 2. The remote console 1 communicates with the clients 3 via the network 2. The remote console 1 is used for controlling the clients 3 to load various operating systems. The remote console 1 and the clients 3 both provide a uniform interaction interface for users. The network 3 may be an intranet, the Internet, or any other type of communications link that follows Transfer Control Protocol (TCP) and Internet Protocol (IP).

The remote console 1 includes a client controlling module 10, a code setting module 11, and an order sending module 12. The client controlling module 10 is used for connecting clients 3 or disconnecting the already connected clients 3. The client controlling module 10 is further used for checking connection statuses periodically between the remote console 1 and the clients 3, and also for determining whether the already connected clients 3 can receive orders from the remote console 1. If the already connected clients 3 can receive orders from the remote console 1, the client controlling module 10 is used for selecting object clients 3 from the clients 3 that can receive orders from the remote console 1.

The code setting module 11 is used for selecting operating systems to be loaded in the object clients 3, and for setting codes of disk partition sections in the object clients 3 to be used for storing the operating systems to be loaded. Generally, there are four disk partition sections that are configured as boot sections. Each boot section stores an operating system and can be expressed by a code. The code corresponds to the operating system stored in the corresponding disk partition section. All the information about the disk partition sections of a hard disk are recorded in a disk partition table (DPT), which is located in the master boot record (MBR) of the hard disk.

The order sending module 12 is used for sending orders and the codes from the remote console 1 to the object clients 3. The orders include rebooting the object clients 3 and loading the operating systems.

The client 3 includes a receiving module 30 and an amending module 32. The receiving module 30 is used for setting statuses of the clients 3 to a receivable mode so as to allow orders from the remote console 1. If the statuses of the object clients 3 are in the receivable mode, the receiving module 30 is further used for receiving the orders and codes from the order sending module 12 and for executing the orders. Otherwise, if the statuses of the object clients 3 are in a not-receivable mode, the receiving module 30 rejects the orders and codes.

The amending module 32 is used for amending the DPTs and configuring the disk partition sections as boot sections according to the set codes issued by the code setting module 11. The disk partition sections store the operating systems to be loaded. After amending the DPTs, the object clients 3 reboot themselves according to the received orders and load the operating systems.

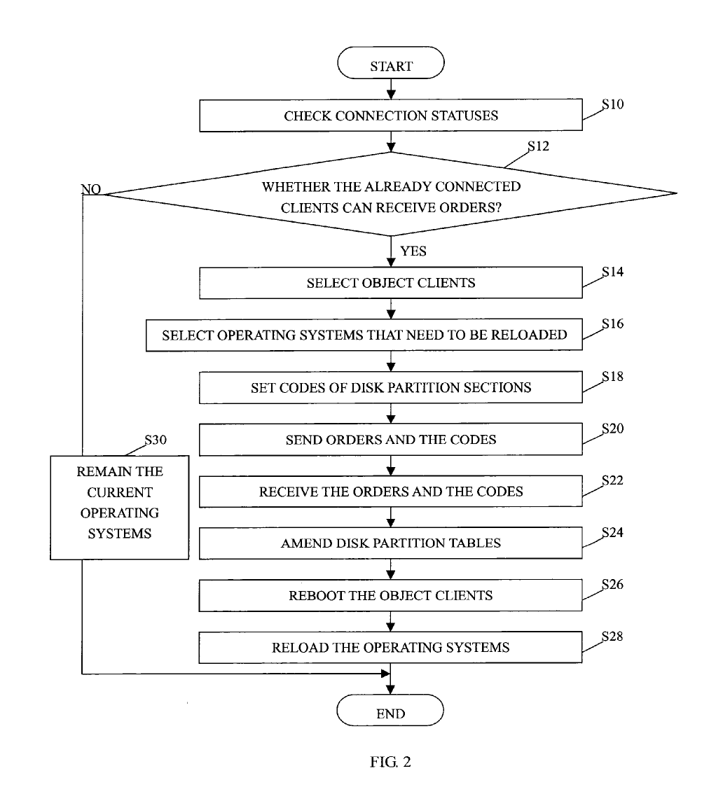

FIG. 2 is a flowchart of a method for loading various operating systems from the remote console 1. In step S10, the client controlling module 10 checks connection statuses between the remote console 1 and the clients 3, and it also connects or disconnects client(s) 3 according to user demands. In step S12, the client controlling module 10 determines whether the already connected clients 3 can receive orders from the remote console 1. If the clients 3 can receive orders from the remote console 1, in step S14, the client controlling module 10 selects object clients 3 from the clients 3 that can receive orders. Otherwise, if the clients 3 cannot receive orders from the remote console 1, in step S30, the clients 3 retain the current operating systems therein.

In step S16, the code setting module 11 selects operating systems that need to be loaded in the object clients 3. In step S18, the code setting module 11 sets codes of disk partition sections in the object clients 3 according to the operating systems to be loaded. In step S20, the order sending module 12 sends orders and the codes to the object clients 3 from the remote console 1. The orders include rebooting the object clients 3 and loading the operating system.

In step S22, the receiving module 30 receives the orders and the codes sent from the remote console 1. In step S24, the amending module 32 in the object clients 3 amends the DPTs and reconfiguring disk partition sections as boot sections according to the codes. The disk partition sections store the operating systems to be loaded in the object clients 3. In step S26, the receiving module 30 executes the received orders to reboot the object clients 3. In step S28, the receiving module 32 loads the operating systems in the object clients 3.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for loading various operating systems, the system comprising multiple clients and at least one remote console, the at least one remote console comprising:
a client controlling module for checking connection statuses between the at least one remote console and the multiple clients, for determining whether the already connected clients can receive orders from the at least one remote console, and for selecting object clients from the clients that can receive orders;
a code setting module for selecting operating systems to be loaded in the object clients, and for setting codes of disk partition sections in the corresponding object clients respectively; and
an order sending module for sending orders and the codes from the at least one remote console to the object clients.

2. The system as claimed in claim 1, wherein each of the multiple clients comprises a receiving module for receiving the orders and the codes, and executing the orders.

3. The system as claimed in claim 1, wherein each of the multiple clients further comprises an amending module for amending disk partition tables and for configuring disk partition sections as boot sections according to the codes.

4. The system as claimed in claim 1, wherein the client controlling module is further used for connecting clients or disconnecting the already connected clients.

5. The system as claimed in claim 1, wherein the client controlling module is further used for checking the connection statuses between the multiple clients and the at least one remote console periodically.

6. The system as claimed in claim 1, wherein the disk partition sections are used for storing the operating systems to be loaded in the object clients.

7. The system as claimed in claim 1, wherein the orders comprise rebooting the object clients and loading the operating systems.

8. The system as claimed in claim 1, wherein the receiving module is further used for setting the statuses of the clients to a receivable mode so as to allow orders from the at least one remote console.

9. A method for loading various operating systems on multiple clients from a remote console, the method comprising the steps of:
checking connection statuses between the remote console and the multiple clients;
determining already connected clients from the multiple clients;
determining whether the already connected clients can receive orders from the remote console;
selecting object clients from the already connected clients that can receive orders from the remote console;
selecting operating systems that need to be loaded in the object clients;
setting codes of disk partition sections in the object clients according to the operating systems to be loaded;
sending orders and the codes to the object clients from the remote console;
receiving the orders and the codes by the object clients;
amending disk partition tables to configure the disk partition sections as boot sections according to the codes;
executing the received orders to reboot the object clients; and
loading the operating systems in the object clients.

10. The method according to claim 9, further comprising the step of connecting clients or disconnecting the already connected clients according to user demands.

11. The method according to claim 9, wherein the determining step comprises the step of retaining the current operating systems of the already connected clients if the already connected clients can not receive orders from the remote console.

12. The method according to claim 9, wherein the disk partition sections is used for storing the operating systems to be loaded in the object clients.
